(19) United States
(12) Patent Application Publication
(10) Pub. No.: US 2017/0141623 A1
(43) Pub. Date: May 18, 2017

(54) WIRELESS POWER TRANSFER SYSTEMS HAVING GUIDES FOR FOREIGN OBJECT REMOVAL AND METHODS OF FABRICATION AND USE OF SAME

(71) Applicant: Elix Wireless Charging Systems Inc., Vancouver (CA)

(72) Inventors: Brice JAMIESON, Richmond (CA); Vitali TIKHOMOLOV, Vancouver (CA)

(21) Appl. No.: 15/384,721

(22) Filed: Dec. 20, 2016

Related U.S. Application Data
(63) Continuation of application No. PCT/CA2015/050623, filed on Jul. 3, 2015.
(60) Provisional application No. 62/021,084, filed on Jul. 4, 2014.

(51) Int. Cl. H02J 50/60; H02J 50/10; H04B 5/00

(52) U.S. Cl. CPC H02J 50/60; H04B 5/0037; H04B 5/0081; H02J 50/10

(57) ABSTRACT

A common problem in wireless charging systems in automotive applications is alignment of the wireless power transfer transmitter and receiver units. Poor alignment leads to poor power transfer capacity and a longer charging time. Costly optical sensors and electromechanical systems may be employed to align the transmitter and receiver units. A solution to this problem is to employ a freely moveable wireless power transmitter in at least one direction that is magnetically attracted to the wireless power receiver unit in the vehicle that does not require electrically powered sensors or mechanical alignment systems.

### RELATED APPLICATIONS

This application is a continuation of Patent Cooperation Treaty (PCT) application No. PCT/CA2015/050623, filed 3 Jul. 2015 and entitled WIRELESS POWER TRANSFER SYSTEMS HAVING GUIDES FOR FOREIGN OBJECT REMOVAL AND METHODS OF FABRICATION AND USE OF SAME, which in turn claims the filing date benefit of U.S. application Ser. No. 62/021084, filed on 4 Jul. 2014. PCT application No. PCT/CA2015/050623 and U.S. application Ser. No. 62/021084 are hereby incorporated herein by reference.

### TECHNICAL FIELD

The invention pertains to wireless power transfer systems which transfer power wirelessly from a wireless power transmitter to a wireless power receiver. Particular embodiments provide wireless power transfer systems having guides for removal of foreign objects from a vicinity (e.g. an air gap) thereof.

### BACKGROUND

Power can be wirelessly conveyed from one place to another using the Faraday effect, whereby a changing magnetic field causes an electrical current to flow in an electrically isolated secondary circuit. A form of wireless power transfer (WPT) currently in use involves magnetic inductive charging. One form of magnetic inductive charging is shown in WPT system 10 of FIG. 1. The FIG. 1 WPT system 10 comprises two coils 12, 14 in close proximity but separated by an air gap 16. One coil 12 of WPT system 10 acts as a wireless power transmitter and the other coil 14 acts as the receiver of wireless power. A time-varying current flows in transmitter coil 12, which produces a time-varying magnetic field (shown as flux lines in FIG. 1). This time-varying magnetic field induces current in the nearby receiver coil 14 (Faraday's law), which can then be used to charge various devices (not shown) which may be electrically connected to receiver coil 14.

In PCT application No. PCT/CA2010/000252 (published under WO/2010/096917), a magnetic-coupling technology has been described to provide a number of viable magnetically-coupled WPT systems that can be used to charge, by way of non-limiting example, batteries generally, electric (e.g. battery operated) vehicles, auxiliary batteries, electric (e.g. battery operated) buses, golf carts, delivery vehicles, boats, drones, trucks and/or the like. FIG. 2 schematically depicts a WPT system 20 incorporating a magnetic-coupling technology of the type described in PCT/CA2010/000252. WPT system 20 comprises a wireless magnetic power transmitter 22 and a wireless magnetic power receiver 24 separated by an air gap 26. The power transfer in WPT system 20 is via rotational magnetic coupling rather than via magnetic induction coupling. In the FIG. 2 WPT system 20, transmitter 22 comprises a permanent magnet 22A and receiver 24 comprises a permanent magnet 24A. Transmitter magnet 22A is rotated (and/or pivoted) about axis 28. The magnetically coupled permanent magnets 22A, 24A interact with one another (magnetic poles represented by an arrow with notations of “N” for north and “S” for south in FIG. 2), such that movement of transmitter magnet 22A about axis causes corresponding movement (e.g. rotation and/or pivotal movement) of receiver magnet 24A about axis 27. The time-varying magnetic fields generated by rotating/pivoting magnets 22A, 24A of WPT system 20 typically have lower frequencies compared to WPT systems based on magnetic induction. The FIG. 2 WPT system 20 transfers power most effectively when there is strong coupling between rotating/pivoting magnets 22A, 24A.

A challenge faced by WPT systems is the presence of foreign objects in the vicinity of the system (e.g. in the air gap between the WPT transmitter and the WPT receiver. Such foreign objects can cause problems ranging from minor to severe, including fires or explosion. The nature and severity of the problems caused by such foreign objects is typically dependent on the material properties of the foreign object. Foreign objections comprising metals may be particularly problematic because of heat generated by eddy currents produced in the metal-containing foreign object in response to the magnetic fields of the WPT system. The problems associated with foreign objects (particularly metals) are associated with both inductive charging WPT systems (of the type shown in FIG. 1) and magneto-dynamic coupling (MDC) WPT systems (of the type shown in FIG. 2). Although the eddy currents produced by the relatively lower-frequency MDC WPT systems are relatively less likely to lead to severe heating causing fire, such eddy currents can still cause undesirable localized heating, reduced power transmission efficiency, power reduction and/or damage to system components, even in MDC WPT systems.

There is a general desire to remove foreign objects (e.g. objects containing metal) from a vicinity of WPT systems. There may be a general desire for such foreign object removal to occur without, or with minimal, user intervention. There may be a general desire to move such foreign objects to positions which minimize the heat generation and/or power loss associated with such objects or which reduce the heat generation and/or power loss associated with such foreign objects to minimal levels.

The foregoing examples of the related art and limitations related thereto are intended to be illustrative and not exclusive. Other limitations of the related art will become apparent to those of skill in the art upon a reading of the description and a study of the drawings.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIG. 1 is a schematic illustration of a prior art magnetic induction based WPT system comprising a WPT transmitter coil and a WPT receiver coil in close proximity.

FIG. 2 is a schematic illustration of two magnetically-coupled rotating/pivoting magnets in a prior art magnetically-coupled WPT system.

FIG. 3 schematically depicts a WPT system comprising a WPT transmitter and a WPT receiver, wherein the WPT transmitter and the WPT receiver each comprise guides for removal of foreign objects from a vicinity of the WPT system according to a particular embodiment.

FIG. 4 schematically depicts a WPT transmitter or WPT receiver comprising a housing with a guide for removal of foreign objects from a vicinity of the WPT system according to a particular embodiment.

FIG. 5 schematically depicts a WPT transmitter or WPT receiver comprising a housing with a guide for removal of foreign objects from a vicinity of the WPT system according to a particular embodiment.

FIG. 6 schematically depicts a WPT transmitter or WPT receiver comprising a housing with a guide for removal of foreign objects from a vicinity of the WPT system according to a particular embodiment.

FIG. 7 schematically depicts a WPT transmitter or WPT receiver comprising a housing with a guide for removal of foreign objects from a vicinity of the WPT system according to a particular embodiment.

FIG. 8 schematically depicts a WPT transmitter or WPT receiver comprising a housing with guides for removal of foreign objects from a vicinity of the WPT system according to a particular embodiment.

FIG. 9 schematically depicts a plan view of a WPT transmitter or WPT receiver comprising a housing with a magnetic sweeper and guides for removal of foreign objects from a vicinity of the WPT system according to a particular embodiment.

FIG. 10 schematically depicts a side view of a WPT transmitter or WPT receiver comprising a housing with a magnetic sweeper and guides for removal of foreign objects from a vicinity of the WPT system according to a particular embodiment.

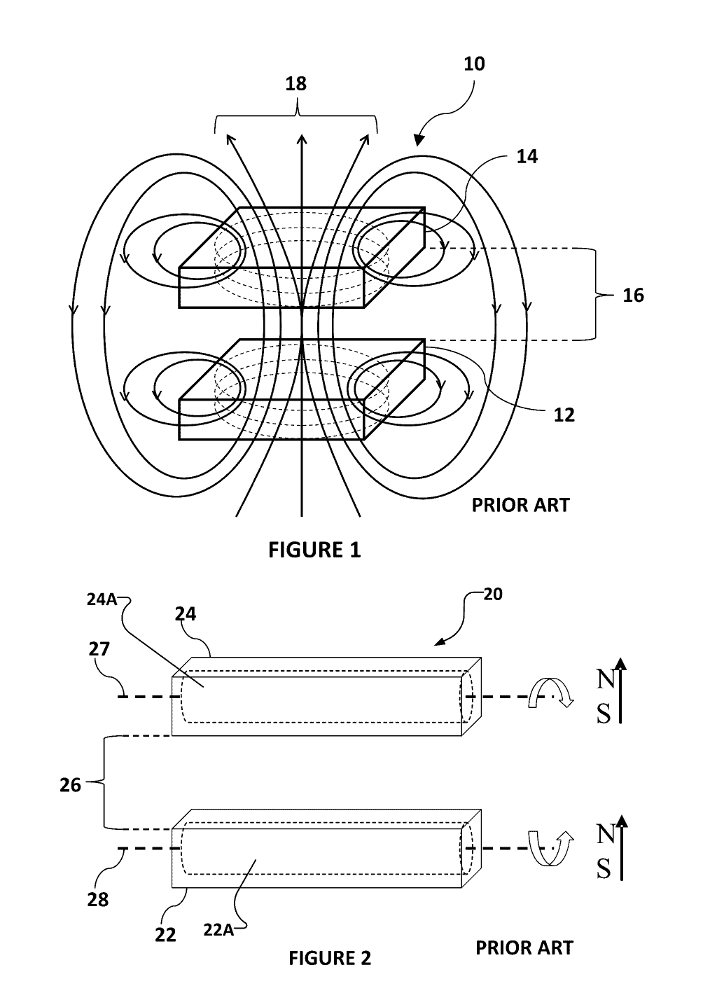

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

One aspect of the invention provides apparatus and methods for removal of foreign metallic objects from the vicinity (e.g. charging region) of a wireless power transfer (WPT) system automatically, which may occur without end user's intervention or even awareness. Foreign objects only need to be moved to positions which minimize the heat generation and/or power loss associated with such objects or which reduce the heat generation and/or power loss associated with such foreign objects to minimal (e.g. suitably small) levels. A guide comprising a textured pattern may be provided on the outward-facing surface of the WPT transmitter and/or WPT receiver in a MDC wireless charging system. For either of the WPT transmitter or the WPT receiver, the guide and/or its textured pattern may be arranged or oriented in such a way that the net force on the foreign object is based primarily on the sum of the force produced by interaction of the object with the magnetic fields of the WPT system (e.g. the magnetic fields of the permanent magnets enclosed in the WPT transmitter and/or the WPT receiver) and the normal force from a guide surface of the guide (e.g. the surface texturing). Such net force may be oriented to force the foreign object toward an end of the WPT transmitter and/or the WPT receiver and/or toward such other safe location, where the magnetic fields associated with the WPT system are at relatively low levels. Once directed to such safe locations, foreign objects may be removed during scheduled maintenance (e.g. some time when charging is complete or power transfer is not otherwise being effected). In some embodiments or circumstances, foreign objects may fall from such safe locations away from the WPT system (e.g. under the force of gravity). In some embodiments, the textured pattern of the guide may be provided in the form of a helical structure (e.g. a helical guide) on the surface of the WPT transmitter and/or the WPT receiver.

Another aspect of the invention provides a wireless power transmitter (also referred to as a WPT transmitter, a wireless power transmitting unit and/or a wireless power transmitting device) for transferring power to a wireless power transfer receiver (also referred to as a WPT receiver, a wireless power receiving unit, and/or a wireless power receiving device). The WPT transmitter and WPT receiver may be parts of a wireless power transfer (WPT) system. The WPT transmitter comprises: a transmitter magnetic system for creating a transmitter magnetic field; and a transmitter housing for supporting the transmitter magnetic system in an interior of the transmitter housing. The magnetic field created by the WPT transmitter has a spatial configuration which moves about a transmitter axis (e.g. pivots or rotates), relative to the transmitter housing. The transmitter housing comprises an outer surface and the outer surface comprises a guide.

The guide may comprise a guide surface which extends in one or more directions such that an orthogonal projection of the one or more extension directions of the guide surface onto a notional plane containing the transmitter axis forms one or more angles, α, with the transmitter axis, wherein 0°<α<90°. The guide may additionally or alternatively comprise a guide surface which extends in one or more directions that are non-parallel with the transmitter axis and non-orthogonal to the transmitter axis. The guide may additionally or alternatively comprise a guide surface which extends in one or more directions which have component directions that are parallel to the transmitter axis and component directions that are orthogonal to the transmitter axis. The guide (and/or its guide surface) may additionally or alternatively extend to wrap around the transmitter axis as the guide (and/or its guide surface) extends in one or more directions aligned with the transmitter axis. The guide may additionally or alternatively comprise at least one of: a flange which is raised relative to a remainder of the outer surface; a groove which is depressed relative to the remainder of the outer surface; and a combination of a flange which is raised relative to the remainder of the outer surface and a groove which is depressed relative to the remainder of the outer surface.

Another aspect of the invention provides a WPT receiver for receiving power from a WPT transmitter. The WPT transmitter and WPT receiver may be parts of a WPT system. The WPT receiver comprises: a receiver magnetic system for creating a receiver magnetic field; and a receiver housing for supporting the receiver magnetic system in an interior of the receiver housing. The receiver magnetic field created by the receiver magnetic system has a spatial configuration which moves about a receiver axis, relative to the receiver housing. The receiver housing comprises an outer surface and the outer surface comprises a guide.

The guide may comprise a guide surface which extends in one or more directions such that an orthogonal projection of the one or more extension directions of the guide surface onto a notional plane containing the receiver axis forms one or more angles, β, with the receiver axis, wherein 0°<β<90°. The guide may additionally or alternatively comprise a guide surface which extends in one or more directions that are non-parallel with the receiver axis and non-orthogonal to the receiver axis. The guide may additionally or alternatively comprise a guide surface which extends in one or more directions which have component directions that are parallel to the receiver axis and component directions that are orthogonal to the receiver axis. The guide (and/or its guide surface) may additionally or alternatively extend to wrap around the receiver axis as the guide (and/or its guide surface) extends in one or more directions aligned with the receiver axis. The guide may additionally or alternatively comprise at least one of: a flange which is raised relative to a remainder of the outer surface; a groove which is depressed relative to the remainder of the outer surface; and a combination of a flange which is raised relative to the remainder of the outer surface and a groove which is depressed relative to the remainder of the outer surface.

Another aspect of the invention provides a method for removing foreign objects from a WPT transmitter (which may form part of a WPT system). The method comprises: providing a transmitter magnetic system for creating a transmitter magnetic field; supporting the transmitter magnetic system in an interior of a transmitter housing; moving a spatial configuration of the transmitter magnetic field about a transmitter axis, relative to the transmitter housing. The transmitter housing comprises an outer surface and the method comprises providing the outer surface with a guide. The method may comprise shaping the guide to provide a guide surface which extends in one or more directions such that an orthogonal projection of the one or more extension directions of the guide surface onto a notional plane containing the transmitter axis forms one or more angles, α, with the transmitter axis, wherein 0°<α<90°. The method may additionally or alternatively comprise shaping the guide to provide a guide surface which extends in one or more directions that are non-parallel with the transmitter axis and non-orthogonal to the transmitter axis. The method may additionally or alternatively comprise shaping the guide to provide a guide surface which extends in one or more directions which have component directions that are parallel to the transmitter axis and component directions that are orthogonal to the transmitter axis. The method may additionally or alternatively comprise shaping the guide (and/or its guide surface) to wrap around the transmitter axis as the guide extends in one or more directions aligned with the transmitter axis. The method may additionally or alternatively comprise shaping the guide, such that the guide comprises at least one of: a flange which is raised relative to a remainder of the outer surface; a groove which is depressed relative to the remainder of the outer surface; and a combination of a flange which is raised relative to the remainder of the outer surface and a groove which is depressed relative to the remainder of the outer surface.

Another aspect of the invention provides a method for removing foreign objects from a WPT receiver (which may form part of a WPT system). The method comprises: providing a receiver magnetic system for creating a receiver magnetic field; supporting the receiver magnetic system in an interior of a receiver housing; moving a spatial configuration of the receiver magnetic field about a receiver axis, relative to the receiver housing. The receiver housing comprises an outer surface and the method comprises providing the outer surface with a guide. The method may comprise shaping the guide to provide a guide surface which extends in one or more directions such that an orthogonal projection of the one or more extension directions of the guide surface onto a notional plane containing the receiver axis forms one or more angles, β, with the transmitter axis, wherein 0°<β<90° The method may additionally or alternatively comprise shaping the guide to provide a guide surface which extends in one or more directions that are non-parallel with the receiver axis and non-orthogonal to the receiver axis. The method may additionally or alternatively comprise shaping the guide to provide a guide surface which extends in one or more directions which have component directions that are parallel to the receiver axis and component directions that are orthogonal to the receiver axis. The method may additionally or alternatively comprise shaping the guide (and/or its guide surface) to wrap around the receiver axis as the guide extends in one or more directions aligned with the receiver axis. The method may additionally or alternatively comprise shaping the guide, such that the guide comprises at least one of: a flange which is raised relative to a remainder of the outer surface; a groove which is depressed relative to the remainder of the outer surface; and a combination of a flange which is raised relative to the remainder of the outer surface and a groove which is depressed relative to the remainder of the outer surface.

Another aspect of the invention provides a magnetically coupled WPT system comprising: at least one WPT transmitter comprising a transmitter housing with a raised or depressed or a combination of a raised and depressed pattern on an outward facing surface thereof; at least one WPT receiver comprising a receiver housing with a raised or depressed or a combination of a raised and depressed pattern on the outward surface; an electrical power source connected to provide power to the WPT transmitter, which in turn transfers the power wirelessly to the WPT receiver.

Another aspect of the invention provides an induction WPT system comprising: at least one WPT transmitter comprising a transmitter housing, a transmitter magnetic system, for creating a transmitter magnetic field, supported within the transmitter housing and a sweeper magnetic system (also referred to herein as a sweeper, for brevity), for creating a sweeper magnetic field, supported within the transmitter housing. The sweeper may comprise one or more permanent magnets and/or one or more suitably configured coils and may be moveable in a sweeper movement direction relative to the transmitter housing. Movement of the sweeper may be linear or rotational. The housing may comprise an outer surface comprising a guide. The guide may comprise a guide surface which extends in one or more directions that form one or more angles, γ, with the sweeper movement direction, wherein 0°<γ<90°. As the sweeper moves, magnetic debris that adhered to the transmitter housing surface is attracted by the sweeper magnetic field and directed toward the guide. As the sweeper continues to move, the guide directs the magnetic debris toward an edge of the transmitter housing for removal.

Another aspect of the invention provides an induction WPT system comprising: at least one WPT receiver comprising a receiver housing, a receiver magnetic system, for creating a receiver magnetic field, supported within the receiver housing and a sweeper magnetic system (also referred to herein as a sweeper, for brevity), for creating a sweeper magnetic field, supported within the receiver housing. The sweeper may comprise one or more permanent magnets and/or one or more suitably configured coils and may be moveable in a sweeper movement direction relative to the receiver housing. Movement of the sweeper may be linear or rotational. The housing may comprise an outer surface comprising a guide. The guide may comprise a guide surface which extends in one or more directions that form one or more angles, θ, with the sweeper movement direction, wherein 0°<θ<90°. As the sweeper moves, magnetic debris that adhered to the receiver housing surface is attracted by the sweeper magnetic field and directed toward the guide. As the sweeper continues to move, the guide directs the magnetic debris toward an edge of the receiver housing for removal.

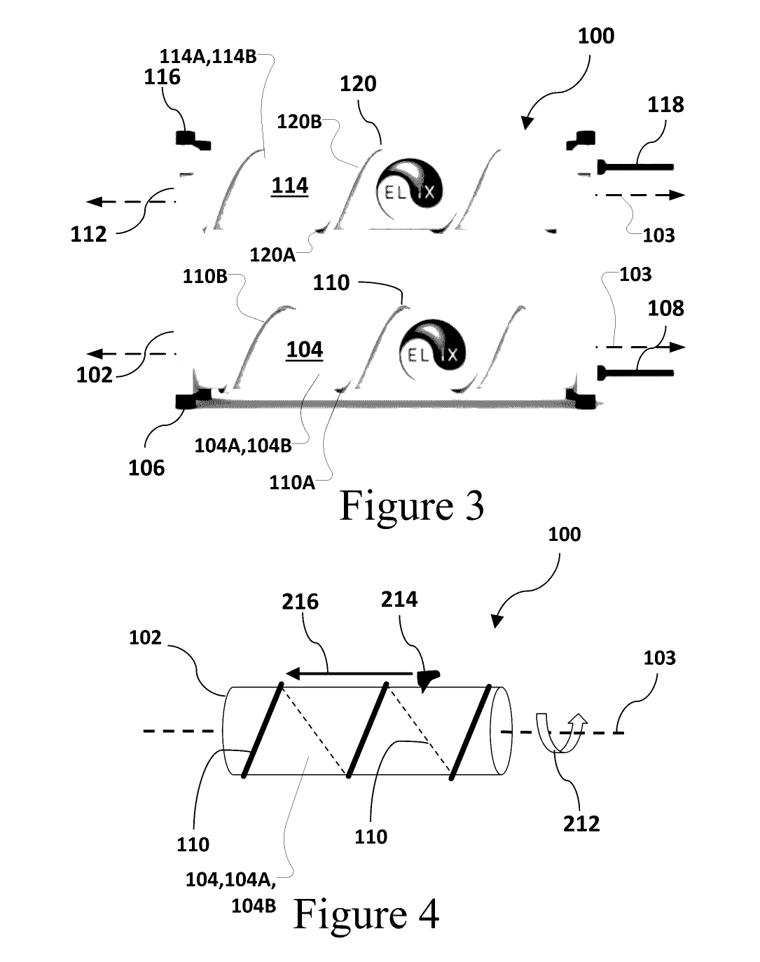

FIG. 3 schematically depicts a wireless power transfer (WPT) system 100 in the form of a wireless charging system 100. WPT system 100 comprises opposing WPT transmitter 102 and WPT receiver 112. WPT transmitter 102 comprises a transmitter magnetic system (not visible in FIG. 3) which may comprise current carrying coils surrounding a magnet rotor for use in a magneto-dynamic coupling (MDC) wireless charging technology. The transmitter magnetic system is supported in an interior of transmitter housing 104. The transmitter magnetic system creates a corresponding transmitter magnetic field which has a spatial configuration which moves about (e.g. pivots and/or rotates) about a transmitter axis 103. Transmitter housing 104 may be constructed of a plastic, rubber or other non-metallic material. In some embodiments, transmitter housing 104 may comprise a soft ferromagnetic material. Transmitter housing 104 comprises an outer surface 104A which, in the illustrated embodiment, comprises a generally cylindrical shape with a cylinder axis which may be aligned with and/or coincident with transmitter axis 103. In the illustrated embodiment, WPT transmitter 102 comprises anchor sites 106 to mount WPT transmitter 102 to a suitable support in a desired location such as, for example, in a wireless charging parking area. WPT transmitter 102 of the FIG. 3 embodiment also comprises an optional conduit 108 through which a power cable may extend to supply electrical power to the transmitter magnetic system. Such power may be used to move the transmitter magnetic field about transmitter axis 103 (e.g. by rotating a permanent magnet rotor in the transmitter magnetic system which may involve providing electrical power to the coils surrounding the permanent magnet rotor).

In the illustrated embodiment, outer surface 104A of transmitter housing 104 also comprises a guide 110 which is raised relative to (i.e. projects outwardly from) a remainder 104B of outer surface 104A to provide a guide surface 110A. Guide 110 of the FIG. 3 embodiment (and/or its guide surface 110A) has a generally helical shape. Guide surface 110A may extend in one or more directions such that an orthogonal projection of the one or more extension directions of guide surface 110A onto a notional plane containing transmitter axis 103 may form one or more angles, α, with transmitter axis 103, wherein 0°<α<90°. Guide surface 110A may extend in one or more directions that are non-parallel with transmitter axis 103 and non-orthogonal to transmitter axis 103. Guide surface 110A may extend in one or more directions which have component directions that are parallel to transmitter axis 103 and component directions that are orthogonal to transmitter axis 103. Guide 110 (and/or its guide surface 110A) may additionally or alternatively extend to wrap around transmitter axis 103 as guide 110 (and/or its guide surface 110A) extends in one or more directions aligned with transmitter axis 103.

In the illustrated FIG. 3 embodiment, guide 110 comprises a flange 110B (e.g. ridges or fins) which is raised relative to (e.g. extends outwardly from) a remainder 104B of outer surface 104A. Guide 110 may additionally or alternatively comprise at least one of: a groove or channel which is depressed relative to the remainder 104B of outer surface 104A; and a combination of a flange which is raised relative to the remainder 104B of outer surface 104A and a groove which is depressed relative to the remainder 104B of outer surface 104A. The flange 110B of guide 110 provides a guide surface 110A which may be of variable height (relative to the remainder 104B of outer surface 104A). Similarly, where guide 110 comprises grooves or channels, such grooves or channels may be of variable depth. Guide 110 may comprise a variable number of flanges and/or grooves that run or wrap around outer surface 104A of transmitter housing 104 and/or around transmitter axis 103. In the illustrated FIG. 3 embodiment, guide 110 comprises a helical shape. Guide 110 need not comprise large number of helical or screw type wraps (about transmitter axis 103) and may comprise fewer that one wrap around axis 103. Guide 110 may be arranged in a right or left-handed direction or a combination of right and left-handed directions in a double-helix type shape. WPT transmitter 102 may comprise a receptacle (not shown) at one or both ends of transmitter housing 104 for collecting foreign objects which may be guided there by guide 110.

In the FIG. 3 WPT system 100, WPT receiver 112 is substantially opposed to and aligned with WPT transmitter 102. WPT receiver 112 comprises a receiver magnetic system (not visible in FIG. 3) which may comprise current carrying coils surrounding a magnet rotor for use in a magneto-dynamic coupling (MDC) wireless charging technology. The receiver magnetic system is supported in an interior of receiver housing 114. The receiver magnetic system interacts with the transmitter magnetic field and in response to such interaction, creates a receiver magnetic field which has a spatial configuration which moves about (e.g. pivots and/or rotates) about a receiver axis 113. Receiver housing 114 may be constructed of a plastic, rubber or other non-metallic material. In some embodiments, receiver housing 114 may comprise a soft ferromagnetic material. Receiver housing 114 comprises an outer surface 114A which, in the illustrated embodiment, comprises a generally cylindrical shape with a cylinder axis which may be aligned with and/or coincident with receiver axis 113. In the illustrated embodiment, WPT receiver 112 comprises anchor sites 106 to mount WPT receiver 112 to a suitable support in a moveable platform such as, for example, in a battery operated vehicle. WPT receiver 112 of the FIG. 3 embodiment also comprises an optional conduit 118 through which a power cable may extend to extract electrical power from the receiver magnetic system.

In the illustrated embodiment, outer surface 114A of receiver housing 114 also comprises a guide 120 which is raised relative to (i.e. projects outwardly from) a remainder 114B of outer surface 114A to provide a guide surface 120A. Guide 120 of the FIG. 3 embodiment (and/or its guide surface 120A) has a generally helical shape. Guide surface 120A may extend in one or more directions such that an orthogonal projection of the one or more extension directions of guide surface 120A onto a notional plane containing receiver axis 113 may form one or more angles, β, with receiver axis 113, wherein 0°<β<90°. Guide surface 120A may extend in one or more directions that are non-parallel with receiver axis 113 and non-orthogonal to receiver axis 113. Guide surface 120A may extend in one or more directions which have component directions that are parallel to receiver axis 113 and component directions that are orthogonal to receiver axis 113. Guide 120 (and/or its guide surface 120A) may additionally or alternatively extend to wrap around receiver axis 113 as guide 120 (and/or its guide surface 120A) extends in one or more directions aligned with receiver axis 113.

In the illustrated FIG. 3 embodiment, guide 120 comprises a flange 120B (e.g. ridges or fins) which is raised relative to (e.g. extends outwardly from) a remainder 114B of outer surface 114A. Guide 120 may additionally or alternatively comprise at least one of: a groove or channel which is depressed relative to the remainder 114B of outer surface 114A; and a combination of a flange which is raised relative to the remainder 114B of outer surface 114A and a groove which is depressed relative to the remainder 114B of outer surface 114A. The flange 120B of guide 120 provides a guide surface 120A which may be of variable height (relative to the remainder 114B of outer surface 114A). Similarly, where guide 120 comprises grooves or channels, such grooves or channels may be of variable depth. Guide 120 may comprise a variable number of flanges and/or grooves that run or wrap around outer surface 114A of receiver housing 114 and/or around receiver axis 113. In the illustrated FIG. 3 embodiment, guide 120 comprises a helical shape. Guide 120 need not comprise large number of helical or screw type turns (about receiver axis 113) and may comprise fewer that one wrap around axis 113. Guide 120 may be arranged in a right or left-handed direction or a combination of right and left-handed directions in a double-helix type shape. WPT receiver 112 may comprise a receptacle (not shown) at one or both ends of receiver housing 114 for collecting foreign objects which may be guided there by guide 120.

FIG. 4 depicts a WPT transmitter 102 of a WPT system 100 according to a particular embodiment and is used to illustrate the mechanism by which guide 110 removes metallic foreign objects and other debris from WPT system 100. It will be appreciated from the discussion that follows that the operation of WPT receiver 112 may be substantially similar to that of WPT transmitter 102 shown in FIG. 4 and described herein. As discussed above, WPT transmitter 102 comprises a transmitter housing 104 with an outer surface 104 comprising a guide 110 having the features described above in connection with FIG. 3. In the FIG. 4 embodiment, it is assumed that WPT transmitter 102 comprises a transmitter magnetic system which comprises a permanent magnet (not shown) rotating about transmitter axis 103 in a counterclockwise direction 212, causing a corresponding counterclockwise rotation of the transmitter magnetic field about transmitter axis 103.

In the FIG. 4 illustration, the dotted lines are used to show guide 110 on an opposite side of outer surface 104A of transmitter housing 104. FIG. 4 depicts an unwanted magnetic foreign object 214 adhered to outer surface 104A of transmitter housing 104 by attraction to the permanent magnet of the transmitter magnet system. As the magnet of transmitter magnetic system rotates in counterclockwise direction 212, the corresponding transmitter magnetic field also rotates and foreign object 214 moves (e.g. by magnetic interaction with the moving transmitter magnetic field) around outer surface 104A of housing 104 (e.g. in a circular manner where transmitter housing 104A has the illustrated cylindrical shape) until foreign object 214 encounters guide 110 (or more particularly, a guide surface 110A of guide 110—see FIG. 3). As the transmitter magnet continues to rotate about transmitter axis 103 and relative to transmitter housing 104, the helical or screw type pattern of guide 110 and its guide surface 110A directs or forces foreign object 214 in direction 216 (leftward in the illustrated FIG. 4 view). Guide 110 can be shaped to direct object 214 into a suitably located receptacle (not shown) or channel or safe location until object 214 can be removed (e.g. during a routine maintenance operation). It is not a requirement that the helical shape of guide 110 comprise any number of wraps around transmitter axis 103. In some embodiments, the helical shape of guide 110 comprises greater than or equal to two wraps around transmitter axis 103. In some embodiments, the helical shape of guide 110 comprises greater than or equal to three wraps around transmitter axis 103. In some embodiments, the helical shape of guide 110 comprises fewer than one full wrap around transmitter axis 103.

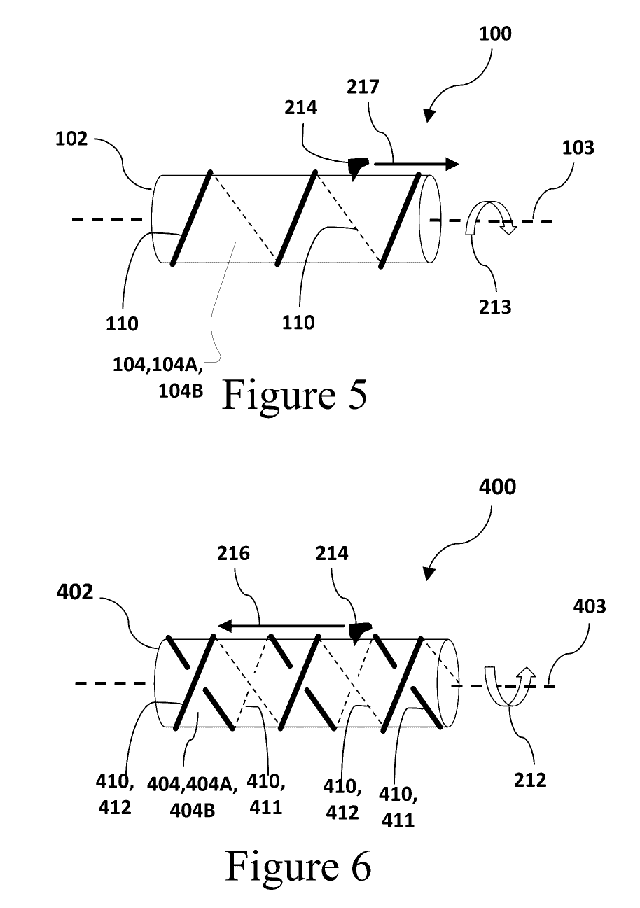

FIG. 5 depicts a WPT transmitter 102 of a WPT system 100 according to a particular embodiment and is used to illustrate the mechanism by which guide 110 removes metallic foreign objects and other debris from WPT system 100. It will be appreciated from the discussion that follows that the operation of WPT receiver 112 may be substantially similar to that of WPT transmitter 102 shown in FIG. 4 and described herein. As discussed above, WPT transmitter 102 comprises a transmitter housing 104 with an outer surface 104 comprising a guide 110 having the features described above in connection with FIG. 3. In the FIG. 5 embodiment, it is assumed that WPT transmitter 102 comprises a transmitter magnetic system which comprises a permanent magnet (not shown) rotating about transmitter axis 103 in a clockwise direction 213 (which is opposite to the rotational direction 212 of FIG. 4), causing a corresponding clockwise rotation of the transmitter magnetic field about transmitter axis 103.

In the FIG. 5 illustration, the dotted lines are used to show guide 110 on an opposite side of outer surface 104A of transmitter housing 104. FIG. 5 depicts an unwanted magnetic foreign object 214 adhered to outer surface 104A of transmitter housing 104 by attraction to the permanent magnet of the transmitter magnet system. As the magnet of transmitter magnetic system rotates in clockwise direction 213, the corresponding transmitter magnetic field also rotates and foreign object 214 moves (e.g. by magnetic interaction with the moving transmitter magnetic field) around outer surface 104A of housing 104 (e.g. in a circular manner where transmitter housing 104A has the illustrated cylindrical shape) until foreign object 214 encounters guide 110 (or more particularly, a guide surface 110A of guide 110). As the transmitter magnet continues to rotate about transmitter axis 103 and relative to transmitter housing 104, the helical or screw type pattern of guide 110 and its guide surface 110A directs or forces foreign object 214 in direction 217 (rightward in the illustrated FIG. 5 view). Guide 110 can be shaped to direct object 214 into a suitably located receptacle (not shown) or channel or safe location until object 214 can be removed (e.g. during a routine maintenance operation). It is not a requirement that the helical shape of guide 110 comprise any number of wraps around transmitter axis 103. In some embodiments, the helical shape of guide 110 comprises greater than or equal to two wraps around transmitter axis 103. In some embodiments, the helical shape of guide 110 comprises greater than or equal to three wraps around transmitter axis 103. In some embodiments, the helical shape of guide 110 comprises fewer than one full wrap around transmitter axis 103.

FIG. 6 depicts a WPT transmitter 402 of a WPT system 400 according to a particular embodiment. It will be appreciated from the discussion that follows that the operation of a WPT receiver having features similar to WPT transmitter 402 may be substantially similar to that of WPT transmitter 402 shown in FIG. 6 and described herein. Like the above-discussed WPT transmitters, WPT transmitter 402 comprises a transmitter housing 404 with an outer surface 404 comprising a guide 410. In the FIG. 6 embodiment, it is assumed that WPT transmitter 402 comprises a transmitter magnetic system which comprises a permanent magnet (not shown) rotating about transmitter axis 403 in a counterclockwise direction 212, causing a corresponding counterclockwise rotation of the transmitter magnetic field about transmitter axis 403. The FIG. 6 transmitter 402 is different than transmitter 102 described above in that the guide 410 of transmitter 402 has a different shape than guide 110 of transmitter 102. In particular, guide 410 of the FIG. 6 embodiment comprises a double-helical shape having guide component 412 and guide component 411, which may be broken where guide component 411 crosses guide component 412. The breaks in guide component 411 provide small spaces through which metal-containing debris can pass. In the FIG. 6 illustration, the dotted lines are used to show guide 410 on an opposite side of outer surface 404A of transmitter housing 404.

FIG. 6 depicts an unwanted magnetic foreign object 214 adhered to outer surface 404A of transmitter housing 404 by attraction to the permanent magnet of the transmitter magnet system. As the magnet of transmitter magnetic system rotates in counterclockwise direction 212, the corresponding transmitter magnetic field also rotates and foreign object 214 moves (e.g. by magnetic interaction with the moving transmitter magnetic field) around outer surface 404A of housing 404 (e.g. in a circular manner where transmitter housing 404A has the illustrated cylindrical shape) until foreign object 214 encounters guide 410 (or more particularly, a guide surface of guide 410). As the transmitter magnet continues to rotate about transmitter axis 403 and relative to transmitter housing 404, the helical or screw type pattern of guide 410 and its guide surface 410A directs or forces foreign object 214 in direction 216 (leftward in the illustrated FIG. 6 view). Guide 410 can be shaped to direct object 214 into a suitably located receptacle (not shown) or channel or safe location until object 214 can be removed (e.g. during a routine maintenance operation). It is not a requirement that the double-helical shape of guide 410 comprise any number of wraps around transmitter axis 403. In some embodiments, the helical shape of each guide component 411, 412 comprises greater than or equal to two wraps around transmitter axis 403. In some embodiments, the helical shape of each guide component 411, 412 comprises greater than or equal to three wraps around transmitter axis 403. In some embodiments, the helical shape of each guide component 411, 412 comprises fewer than one full wrap around transmitter axis 403.

In general, for MDC WPT systems, the transmitter and receiver magnetic fields can be caused to move about their respective transmitter/receiver axes in either angular direction (e.g. by suitable pivotal and/or rotational movement of the permanent magnet(s) in their respective magnetic systems). Guides 110, 410 may be shaped to allow for magnetic foreign objects to be forced toward either end of the corresponding transmitter housing 104, 404 as illustrated in FIGS. 4-6. In the embodiments of FIG. 4-6, the magnetic foreign objects will be forced toward either end of the outward surface 104A, 404A of the cylindrical transmitter/receiver housing 104, 404, depending on the direction in which the transmitter/receiver magnetic field moves about axis 103, 403 and the direction of the helical guide 110, 410 wrapping around axis 103, 403. For metallic materials that are non-magnetic (e.g. aluminum and/or the like), the eddy currents produced in the electrically conductive metal by the moving magnetic fields associated with WPT system are beneficial to removal. Such non-magnetic metaling objects will be forcefully expelled from the charging region of WPT system as the field produced by eddy-currents in the metal will oppose the field of the WPT system and produce a net force on the foreign object which causes the object to be expelled.

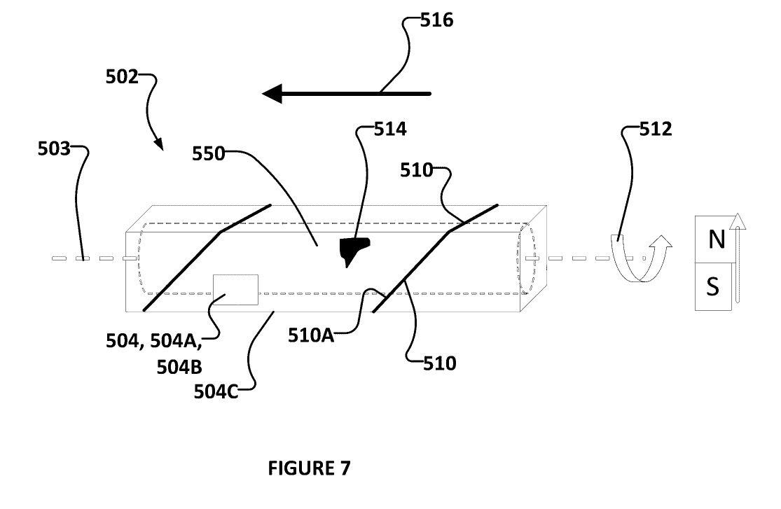

FIG. 7 depicts a WPT transmitter 502 according to a particular embodiment and is used to illustrate the mechanism by which guide 510 removes metallic foreign objects and other debris from a WPT system. It will be appreciated from the discussion that follows that the operation of a WPT receiver may be substantially similar to that of WPT transmitter 502 shown in FIG. 7 and described herein. As discussed above, WPT transmitter 502 comprises a transmitter housing 504 with an outer surface 504A comprising a guide 510 having many of the features described above in connection with FIG. 3. In the FIG. 7 embodiment, it is assumed that WPT transmitter 502 comprises a transmitter magnetic system which comprises a permanent magnet 550 rotating about transmitter axis 503 in a counterclockwise direction 512. In the FIG. 7 illustration, the dotted lines are used to show guide 510 on an opposite side of outer surface 504A of transmitter housing 504.

WPT transmitter 502 comprises a transmitter magnetic system 550 which may comprise current carrying coils surrounding a magnet rotor for use in a magneto-dynamic coupling (MDC) wireless charging technology. The transmitter magnetic system is supported in an interior of transmitter housing 504. The transmitter magnetic system creates a corresponding transmitter magnetic field which has a spatial configuration which moves about (e.g. pivots and/or rotates) about a transmitter axis 503. Transmitter housing 504 may be constructed of a plastic, rubber or other non-metallic material. In some embodiments, transmitter housing 504 may comprise a soft ferromagnetic material. Transmitter housing 504 comprises an outer surface 504A which, in the illustrated embodiment, comprises a generally polyhedral (e.g. tetrahedral or cuboid) shape with a longitudinal axis which may be aligned with and/or coincident with transmitter axis 503. In some embodiments, the polyhedral shape is a cuboid. In some embodiments, WPT transmitter 502 comprises anchor sites (not shown in FIG. 7) to mount WPT transmitter 502 to a suitable support in a desired location such as, for example, in a wireless charging parking area. WPT transmitter 502 may also comprise an optional conduit (not shown in FIG. 7) through which a power cable may extend to supply electrical power to the transmitter magnetic system. Such power may be used to move the transmitter magnetic field about transmitter axis 503 (e.g. by rotating a permanent magnet rotor in the transmitter magnetic system which may involve providing electrical power to the coils surrounding the permanent magnet rotor).

In the illustrated embodiment, outer surface 504A of transmitter housing 504 also comprises a guide 510 which may be raised relative to (i.e. project outwardly from) a remainder 504B of outer surface 504A to provide a guide surface 510A. Guide 510 of the FIG. 7 embodiment (and/or its guide surface 510A) has a quasi-helical shape with a non-circular cross-section as depicted in FIG. 7. Guide surface 510A may extend in one or more directions such that an orthogonal projection of the one or more extension directions of guide surface 510A onto a notional plane containing transmitter axis 503 may form one or more angles, α, with transmitter axis 503, wherein 0°<α<90°. Guide surface 510A may extend in one or more directions that are non-parallel with transmitter axis 503 and non-orthogonal to transmitter axis 503. Guide surface 510A may extend in one or more directions which have component directions that are parallel to transmitter axis 503 and component directions that are orthogonal to transmitter axis 503. Guide 510 (and/or its guide surface 510A) may additionally or alternatively extend to wrap around transmitter axis 503 as guide 510 (and/or its guide surface 510A) extends in one or more directions aligned with transmitter axis 503.

In some embodiments, guide 510 comprises a flange (e.g. ridges or fins) which may be raised relative to (e.g. extends outwardly from) a remainder 504B of outer surface 504A. In other embodiments, guide 510 may additionally or alternatively comprise at least one of: a groove or channel which is depressed relative to the remainder 504B of outer surface 504A; and a combination of a flange which is raised relative to the remainder 504B of outer surface 504A and a groove which is depressed relative to the remainder 504B of outer surface 504A. The flange of guide 510 provides a guide surface 510A which may be of variable height (relative to the remainder 504B of outer surface 504A). Similarly, where guide 510 comprises grooves or channels, such grooves or channels may be of variable depth. Guide 510 may comprise a variable number of flanges and/or grooves that run or wrap around outer surface 504A of transmitter housing 504 and/or around transmitter axis 503. In the illustrated FIG. 7 embodiment, guide 510 comprises a generally helical shape. Guide 510 need not comprise a large number of helical or screw type wraps (about transmitter axis 503) and may comprise fewer that one wrap around axis 503. Guide 510 may be arranged in a right or left-handed direction or a combination of right and left-handed directions in a double-helix type shape. WPT transmitter 502 may comprise a receptacle (not shown) at one or both ends of transmitter housing 504 for collecting foreign objects which may be guided there by guide 510.

FIG. 7 depicts an unwanted magnetic foreign object 514 adhered to outer surface 504A of transmitter housing 504 by attraction to the permanent magnet of the transmitter magnetic system. As the magnet of transmitter magnetic system rotates in counterclockwise direction 512, the corresponding transmitter magnetic field also rotates and foreign object 514 moves (e.g. by magnetic interaction with the moving transmitter magnetic field) around outer surface 504A of housing 504 (e.g. in a manner corresponding to the cross-sectional shape of transmitter housing 504A) until foreign object 514 encounters guide 510 (or more particularly, a guide surface 510A of guide 510—see FIG. 7). As the transmitter magnet continues to rotate about transmitter axis and relative to transmitter housing 504, the helical or screw type pattern of guide 510 and its guide surface 510A directs or forces foreign object 514 in direction 516 (leftward in the illustrated FIG. 7 view). Unlike in the FIG. 4 embodiment, foreign object 514 may be guided over corners 504C of housing 504. Guide 510 can be shaped to direct object 514 into a suitably located receptacle (not shown) or channel or safe location until object 514 can be removed (e.g. during a routine maintenance operation). In some embodiments, the quasi-helical shape of guide 510 comprise greater than or equal to two wraps around transmit axis 503. In some embodiments, the quasi-helical shape of guide 510 comprise greater than or equal to three wraps around transmit axis 503. In some embodiments, the quasi-helical shape of guide 510 comprises fewer than one full wrap around transmitter axis 403.

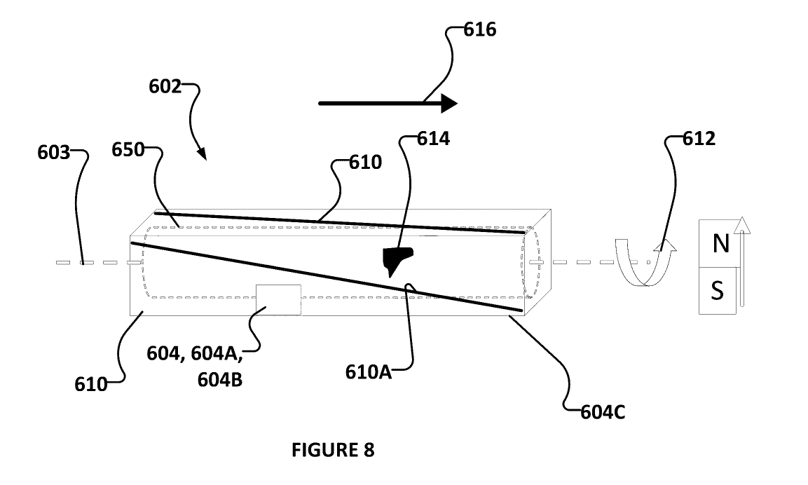

FIG. 8 depicts a WPT transmitter 602 according to a particular embodiment and is used to illustrate the mechanism by which guide 610 removes metallic foreign objects and other debris from a WPT system. It will be appreciated from the discussion that follows that the operation of a WPT receiver may be substantially similar to that of WPT transmitter 602 shown in FIG. 8 and described herein. As discussed above, WPT transmitter 602 comprises a transmitter housing 604 with an outer surface 604A comprising a plurality of guides 610 having many of the features described above in connection with FIG. 3. In the FIG. 8 embodiment, it is assumed that WPT transmitter 602 comprises a transmitter magnetic system which comprises a permanent magnet 650 rotating about transmitter axis 603 in a counterclockwise direction 612. In the FIG. 8 illustration, the dotted lines are used to show guides 610 on opposite sides of outer surface 604A of transmitter housing 604.

WPT transmitter 602 comprises a transmitter magnetic system 650 which may comprise current carrying coils surrounding a magnet rotor for use in a magneto-dynamic coupling (MDC) wireless charging technology. The transmitter magnetic system is supported in an interior of transmitter housing 604. The transmitter magnetic system creates a corresponding transmitter magnetic field which has a spatial configuration which moves about (e.g. pivots and/or rotates) about a transmitter axis 603. Transmitter housing 604 may be constructed of a plastic, rubber or other non-metallic material. In some embodiments, transmitter housing 604 may comprise a soft ferromagnetic material. Transmitter housing 604 comprises an outer surface 604A which, in the illustrated embodiment, comprises a generally polyhedral (e.g. tetrahedral or cuboid) shape with a longitudinal axis which may be aligned with and/or coincident with transmitter axis 603. In some embodiments, the polyhedral shape is a cuboid. In some embodiments, WPT transmitter 602 comprises anchor sites (not shown in FIG. 8) to mount WPT transmitter 602 to a suitable support in a desired location such as, for example, in a wireless charging parking area. WPT transmitter 602 may also comprise an optional conduit (not shown in FIG. 8) through which a power cable may extend to supply electrical power to the transmitter magnetic system. Such power may be used to move the transmitter magnetic field about transmitter axis 603 (e.g. by rotating a permanent magnet rotor in the transmitter magnetic system which may involve providing electrical power to the coils surrounding the permanent magnet rotor).

In the illustrated embodiment, outer surface 604A of transmitter housing 604 also comprises a plurality of guides 610 which may be raised relative to (i.e. projects outwardly from) a remainder 604B of outer surface 604A to provide a guide surface 610A. Each guide 610 of the FIG. 8 embodiment (and/or its guide surface 610A) has a generally linear shape. Unlike the FIG. 7 embodiment, each guide 610 of the FIG. 8 embodiment extends across only a single side of housing 604. Each guide surface 610A may extend in one or more directions such that an orthogonal projection of the one or more extension directions of each guide surface 610A onto a notional plane containing transmitter axis 603 may form one or more angles, α, with transmitter axis 603, wherein 0°<α<90°. Each guide surface 610A may extend in one or more directions that are non-parallel with transmitter axis 603 and non-orthogonal to transmitter axis 603. Each guide surface 610A may extend in one or more directions which have component directions that are parallel to transmitter axis 603 and component directions that are orthogonal to transmitter axis 603.

In some embodiments, guide 610 comprises a flange (e.g. ridges or fins) which may be raised relative to (e.g. extends outwardly from) a remainder 604B of outer surface 604A. In other embodiments, guide 610 may additionally or alternatively comprise at least one of: a groove or channel which is depressed relative to the remainder 604B of outer surface 604A; and a combination of a flange which is raised relative to the remainder 604B of outer surface 604A and a groove which is depressed relative to the remainder 604B of outer surface 604A. The flange of guide 610 provides a guide surface 610A which may be of variable height (relative to the remainder 604B of outer surface 604A). Similarly, where guide 610 comprises grooves or channels, such grooves or channels may be of variable depth. Guide 610 may comprise a variable number of flanges and/or grooves that run along outer surface 604A of transmitter housing 604. In the illustrated FIG. 8 embodiment, each longitudinal side of housing 604 comprises a guide 610. Each guide 610 comprises a generally linear shape. In other embodiments, guide 610 may not be linear. WPT transmitter 602 may comprise a receptacle (not shown) at one or both ends of transmitter housing 604 for collecting foreign objects which may be guided there by guide 610.

FIG. 8 depicts an unwanted magnetic foreign object 614 adhered to outer surface 604A of transmitter housing 604 by attraction to the permanent magnet of the transmitter magnet system. As the magnet of transmitter magnetic system rotates in counterclockwise direction 612, the corresponding transmitter magnetic field also rotates and foreign object 614 moves (e.g. by magnetic interaction with the moving transmitter magnetic field) around outer surface 604A of housing 604 (e.g. in a non-circular manner where transmitter housing 604A has the illustrated polyhedral shape) until foreign object 614 encounters a guide 610 (or more particularly, a guide surface 610A of a guide 610—see FIG. 8). As the transmitter magnet continues to rotate about transmitter axis and relative to transmitter housing 604, the linear extension of guide 610 and its guide surface 610A directs or forces foreign object 614 in direction 616 (rightward in the illustrated FIG. 8 view). Unlike in the FIG. 7 embodiment, foreign object 614 is not guided over the corners of housing 604. Instead, each individual guide 610 directs foreign object 614 from left to right on a single face of housing 604. Guide 610 can be shaped to direct object 614 into a suitably located receptacle (not shown) or channel or safe location until object 614 can be removed (e.g. during a routine maintenance operation).

A competitive advantage of the WPT systems with debris removal systems as described here is associated with magneto-dynamic coupling (MDC) WPT systems where the rotating magnetic field in the MDC WPT system naturally produces forces on any foreign metallic objects which can then be directed away from the charging region. The magnetic fields rotate around the axes of the WPT transmitter and WPT receiver and twice per cycle there will be a magnetic pole pointing away from the charging region entirely. In contrast, inductive coupling systems typically operate on a time-varying magnetic field which points predominantly along the axis between transmitter and receiver (e.g. an axis corresponding to the coil(s) associated with the transmitter and receiver magnetic systems) and varies in amplitude rather than direction. In the MDC wireless charging system, the rotation of the field in normal operation is enough to remove small foreign objects in a manner of seconds, while larger ferromagnetic objects could be removed by slowing the charger rotation for a few seconds until they are automatically expelled.

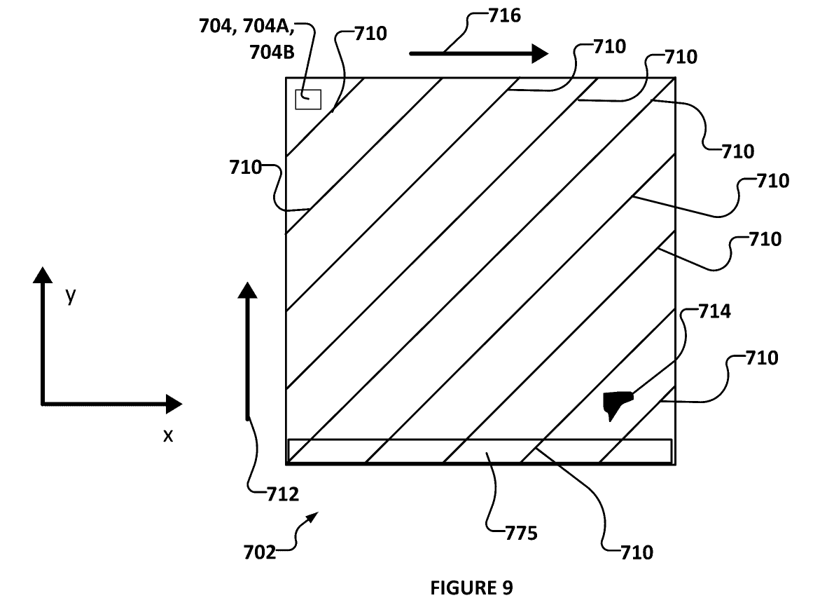

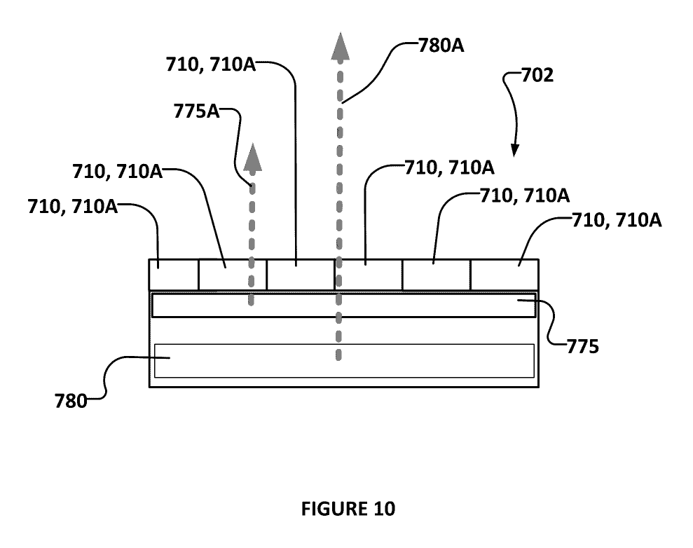

FIGS. 9 and 10 depict a WPT transmitter 702 of an inductive wireless power transfer system according to a particular embodiment and is used to illustrate the mechanism by which sweeper 775 removes metallic foreign objects and other debris from an inductive wireless power transfer system. It will be appreciated from the discussion that follows that the operation of a WPT receiver may be substantially similar to that of WPT transmitter 702 shown in FIGS. 9 and 10 and described herein. WPT transmitter 702 comprises a transmitter housing 704 having a sweeper magnetic system 775 therein and an outer surface 704A comprising a plurality of guides 710. In the FIG. 9 embodiment, it is assumed that WPT transmitter 702 comprises a transmitter magnetic system which comprises a plurality of coils 780 energized to create a transmitter magnetic field 780A that varies with time to thereby transfer power to a WPT receiver (not shown).

WPT transmitter 702 comprises a transmitter magnetic system comprising a plurality of magnetic field generating coils 780 which may be used for induction power transfer. The transmitter magnetic system is supported in an interior of transmitter housing 704. The transmitter magnetic system creates a corresponding transmitter magnetic field 780A which has a spatial configuration which varies with time. Transmitter housing 704 may be constructed of a plastic, rubber or other non-metallic material. In some embodiments, transmitter housing 704 may comprise a soft ferromagnetic material. Transmitter housing 704 comprises an outer surface 704A which, in the illustrated embodiment, comprises a generally polyhedral (e.g. tetrahedral or cuboid) shape. This is not mandatory. In other embodiments, outer surface 704A may be rounded (e.g. cylindrical or conical). In some embodiments, WPT transmitter 702 comprises anchor sites (not shown in FIGS. 9 and 10) to mount WPT transmitter 702 to a suitable support in a desired location such as, for example, in a wireless charging parking area. WPT transmitter 702 may also comprise an optional conduit (not shown in FIGS. 9 and 10) through which a power cable may extend to supply electrical power to the transmitter magnetic system. Such power may be used to vary transmitter magnetic field 780A (e.g. by energizing and/or varying the energization of coils 780).

In the illustrated embodiment, WPT transmitter 702 comprises a sweeper 775. Sweeper 775 may be supported for movement, in a direction 712, within housing 704. Sweeper 775 may comprise one or more magnetic field generating units such as, permanent magnets and/or magnetic field generating coils. The one or more magnetic field generating units of sweeper 775 create sweeper magnetic field 775A. As can be seen from FIG. 9, sweeper 775 is generally elongated in the x-direction and has a width in the y-direction. An x-direction dimension of sweeper 775 may be substantially the same as an x-direction dimension of housing 704. In some embodiments, the x-direction dimension of sweeper 775 is between 50% and 95% of the length as the x-direction dimension of housing 704. In other embodiments, the x-direction dimension of sweeper 775 is greater than 95% of the length of the x-direction dimension of housing 704. In some embodiments, sweeper 775 may have a different geometry, such as a geometry corresponding to the shape of outer surface 704A of housing 704. Sweeper 775 may be movable in one or more directions 712. For example, in the illustrated embodiment, sweeper 775 may be translated back and forth in the y-direction. In other embodiments, sweeper 775 may be pivoted or rotated as desired. Sweeper 775 may be moved by a drive system such as a separate motor (electric or otherwise) and may be supported for movement by one or more of tracks, rails, pulleys, cables, bearings etc. As sweeper 775 is moved in the direction of movement 712, the sweeper magnetic field 775A also moves in the direction of movement 712. In this way, sweeper magnetic field 775A may be a spatially varying magnetic field.

In the illustrated embodiment, outer surface 704A of transmitter housing 704 also comprises a plurality of guides 710 which may be raised relative to (i.e. project outwardly from) a remainder 704B of outer surface 704A to provide a plurality of guide surfaces 710A. Guides 710 of the FIGS. 9 and 10 embodiment (and/or guide surfaces 710A) have a substantially linear shape as depicted in FIG. 9. In addition to extending in directions aligned with the dominant transmitter magnetic field direction 780A (e.g. the axial direction 780A of the transmitter coil(s) used to create the transmitter magnetic field), guide surfaces 710A may also extend in one or more directions orthogonal to the dominant transmitter magnetic field direction 780A. Guide surface 710A may extend in one or more directions that are non-parallel with the direction of movement 712 of sweeper 775 and non-orthogonal to the direction of movement 712 of sweeper 775. Guide surface 710A may form one or more angles, γ, with direction of movement 712 of sweeper 775, wherein 0°<γ<90°. Guide surface 710A may extend in one or more directions which have component directions that are parallel to direction of movement 712 of sweeper 775 and component directions that are orthogonal to direction of movement 712 of sweeper 775.

In some embodiments, guides 710 comprise a flange (e.g. ridges or fins) which may be raised relative to (e.g. extends outwardly from) a remainder 704B of outer surface 704A. In other embodiments, guides 710 may additionally or alternatively comprise at least one of: a groove or channel which is depressed relative to the remainder 704B of outer surface 704A. The flange of guides 710 provides guide surfaces 710A which may be of variable height (relative to the remainder 704B of outer surface 704A). Similarly, where guides 710 comprise grooves or channels, such grooves or channels may be of variable depth. Guides 710 may comprise a variable number of flanges and/or grooves that run across or around outer surface 704A of transmitter housing 704. Guides 710 need not comprise large number of flanges or grooves. WPT transmitter 702 may comprise a receptacle (not shown) at one or both ends of transmitter housing 704 for collecting foreign objects which may be guided there by guides 710.

FIG. 9 depicts an unwanted magnetic foreign object 714 adhered to outer surface 704A of transmitter housing 704 by attraction to transmitter magnetic field 780A. The presence of foreign object 714 may be detected automatically (e.g. by a loss in efficiency) or may be detected manually. Upon detection of foreign object 714, transmission of power by transmitter 702 may be shut off to allow for removal of foreign object 714 by sweeper 775 and guides 710. After transmission of power by transmitter 702 is shut off, sweeper 775 may be energized (if necessary to create sweeper magnetic field 775A) and may be moved in the direction of movement 712. As sweeper 775 is moved in the direction of movement 712, it will pass under foreign object 714 which will be attracted thereto by sweeper magnetic field 775A. Foreign object 714 will therefore move in the direction of movement 712 until foreign object 714 encounters guide 710 (or more particularly, a guide surface 710A of guide 710). As sweeper 775 continues to move in the direction of movement 712, guide surface 710A directs or forces foreign object 714 in direction 716 (rightward in the illustrated FIG. 9 view). Guide 710 can be shaped to direct object 714 into a suitably located receptacle (not shown) or channel or safe location until object 714 can be removed (e.g. during a routine maintenance operation). In some embodiments, outer surface 704A of WPT transmitter 702 does not comprise guide 710 and when sweeper 775 is moved in direction of movement 712, foreign object 714 is directed to an edge of outer surface 704A without the aid of a guide.

Aspects of the present invention facilitate the removal of deleterious magnetic and non-magnetic metallic foreign objects from the vicinity of (e.g. the air gap between) the WPT transmitter and WPT receiver in magneto-dynamic coupling MDC WPT and induction WPT (e.g. wireless charging) systems. Aspects of the present invention may be used in mobile applications such as, but not limited to, electric powered automobiles, transit buses, delivery vehicles, golf carts, underwater remote operated vehicles or trucks.

Embodiments of the invention described herein may be used in any magnetically-coupled wireless charging systems and induction wireless charging systems for, but not limited to, electric powered automobiles, transit buses, delivery vehicles, trucks, drones, boats, golf carts or other consumer devices. Particular embodiments allow for low cost and low maintenance automatic wireless charging stations of simple construction and assembly and further encourage adoption of electric vehicle technology.

As will be apparent to those skilled in the art in the light of the foregoing disclosure, many alterations and modifications are possible in the practice of this invention without departing from the spirit or scope thereof. For example:
Various embodiments described herein may each include a variety of features. It should be understood that this description and the accompanying claims include additional embodiments that comprise combinations of any of the features of any of the embodiments herein.
In some instances, this description and the accompanying claims use terms generally to describe directions, orientations, shapes, relationships (e.g. equalities) and/or the like. For example, transmitter magnetic system may have a first magnetization direction that is orthogonal to a transmitter magnetization-variation direction. Such directions, orientations, shapes, relationships and/or the like should be considered to accommodate the specified directions, orientations, shapes, relationships and/or the like and/or relatively small deviations (from an operational or engineering perspective) from the specified directions, orientations, shapes, relationships and/or the like.
In some instances, this description and the accompanying claims refer to receiver magnetic systems. Where the receiver magnetic systems comprise coils, the reference to receiver magnetic system is a matter of nomenclature and doesn't necessarily mean that the receiver magnetic system is driven to generate corresponding magnetic fields. In practice, the receiver magnetic system may instead have currents induced therein, which induced currents may in turn create corresponding magnetic fields.
In this description and the accompanying claims, elements (such as, by way of non-limiting example, WPT transmitters and WPT receivers) are said to overlap or align with one another in a direction or along a direction. For example, a WPT receiver may overlap or be aligned with a WPT receiver along a particular direction. When it is described that two or more objects overlap or are aligned in or along a particular direction, this usage should be understood to mean that line oriented in that particular direction could be drawn to intersect the two or more objects.

While a number of exemplary aspects and embodiments have been discussed above, those of skill in the art will recognize certain modifications, permutations, additions and sub-combinations thereof. It is therefore intended that the following appended aspects or claims and aspects or claims hereafter introduced are interpreted to include all such modifications, permutations, additions and sub-combinations.

What is claimed is:

1. A wireless power transmitter for transferring power to a wireless power receiver, the wireless power transmitter comprising:
a transmitter magnetic system for creating a transmitter magnetic field;
a transmitter housing for supporting the transmitter magnetic system in an interior of the transmitter housing;
the transmitter magnetic field having a spatial configuration which varies about a transmitter axis, relative to the transmitter housing;
the transmitter housing comprising an outer surface, the outer surface comprising a guide; and
the guide comprising a guide surface which extends in one or more directions such that an orthogonal projection of the one or more extension directions of the guide surface onto a notional plane containing the transmitter axis forms one or more angles, α, with the transmitter axis, wherein 0°<α<90°.

2. A wireless power transmitter according to claim 1 wherein the transmitter magnetic system comprises one or more magnets for creating the transmitter magnetic field.

3. A wireless power transmitter according to claim 1 wherein the transmitter magnetic system comprises one or more magnets for creating the transmitter magnetic field, the one or more magnets rotatable about the transmitter axis.

4. A wireless power transmitter according to claim 1 wherein the transmitter magnetic system comprises one or more magnetic field generating coils.

5. A wireless power transmitter according to claim 1 wherein the transmitter magnetic system comprises one or more magnetic field generating coils, the one or more magnetic field generating coils rotatable about the transmitter axis.

6. A wireless power transmitter according to claim 1 wherein moving the spatial configuration of the transmitter magnetic field comprises moving the transmitter magnetic system.

7. A wireless power transmitter according to claim 1 wherein the spatial configuration of the transmitter magnetic field comprises one or more of: a direction of the transmitter magnetic field at a given location and a magnitude of the transmitter magnetic field at a given location.

8. A wireless power transmitter according to claim 1 wherein the guide extends across more than 75% of the longitudinal dimension of the outer surface of the transmitter housing.

9. A wireless power transmitter according to claim 1 wherein the guide extends across the entire longitudinal dimension of the outer surface of the transmitter housing.

10. A wireless power transmitter according to claim 1 wherein the guide is substantially helical in shape.

11. A wireless power transmitter according to claim 10 wherein a cross-section of the helical guide is substantially non-circular in shape.

12. A wireless power transmitter according to claim 1 wherein the guide extends 360° or more about the transmitter axis and around the transmitter housing.

13. A wireless power transmitter according to claim 1 wherein the guide extends about the transmitter axis and around the transmitter housing at least two times.

14. A wireless power transmitter according to claim 1 wherein the guide extends less than 360° about the transmitter axis and around the transmitter housing.

15. A wireless power transmitter according to claim 14 wherein a pitch of the helical shape of the guide is variable along the longitudinal dimension of the outer surface of the transmitter housing.

16. A wireless power transmitter according to claim 1 wherein the guide comprises multiple extensions.

17. A wireless power transmitter according to claim 16 wherein each one of the multiple extensions of the guide is disjointed from the remainder of the multiple extensions.

18. A wireless power transmitter according to claim 1 wherein the guide comprises at least one of: a flange which is raised relative to a remainder of the outer surface; a groove which is depressed relative to the remainder of the outer surface; and a combination of a flange which is raised relative to the remainder of the outer surface and a groove which is depressed relative to the remainder of the outer surface.

19. A wireless power transmitter according to claim 1 wherein the guide has a height or a depth that varies across the longitudinal dimension of the outer surface of the transmitter housing.

20. A wireless power receiver for receiving power from a wireless power transmitter, the wireless power receiver comprising:
a receiver magnetic system for creating a receiver magnetic field;
a receiver housing for supporting the receiver magnetic system in an interior of the receiver housing;
the receiver magnetic field having a spatial configuration which varies about a receiver axis, relative to the receiver housing;
the receiver housing comprising an outer surface, the outer surface comprising a guide; and
the guide comprising a guide surface which extends in one or more directions such that an orthogonal projection of the one or more extension directions of the guide surface onto a notional plane containing the receiver axis forms one or more angles, β, with the receiver axis, wherein 0°<β<90°.

21. A method for removing foreign objects from a wireless power transmitter, the method comprising:
providing a transmitter magnetic system for creating a transmitter magnetic field;
supporting the transmitter magnetic system in an interior of a transmitter housing, the transmitter housing comprises an outer surface;
moving a spatial configuration of the transmitter magnetic field about a transmitter axis, relative to the transmitter housing;
providing the outer surface with a guide; and
shaping the guide to provide a guide surface which extends in one or more directions such that an orthogonal projection of the one or more extension directions of the guide surface onto a notional plane containing the transmitter axis forms one or more angles, α, with the transmitter axis, wherein 0°<α<90°.

22. A method according to claim 21 comprising detecting a foreign object interfering with the wireless power transmitter; and adjusting the speed of movement of the spatial configuration of the transmitter magnetic field in response to detecting the foreign object interfering with the wireless power transmitter.

23. A method according to claim 21 comprising guiding the foreign object along the transmitter axis to an edge of the outer surface of the transmitter housing.
